(19) United States
(12) Patent Application Publication
(10) Pub. No.: US 2006/0192382 A1
(43) Pub. Date: Aug. 31, 2006

(54) Plumbing adapter

(76) Inventor: John Martineau, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 11/418,046

(22) Filed: May 4, 2006

Related U.S. Application Data
(63) Continuation-in-part of application No. 10/996,731, filed on Nov. 24, 2004.
(60) Provisional application No. 60/583,103, filed on Jun. 25, 2004.

(51) Int. Cl. F16L 21/06

(52) U.S. Cl. 285/323

(57) ABSTRACT

The invention relates to a plumbing adapter for connecting rough plumbing to finished plumbing, including an inlet adapted to be attached to the rough plumbing, an outlet having an outer diameter adapted to be attached to the finished plumbing, and a connector having a first end attached to the inlet and a second end with an inner diameter adapted to fit around the outer diameter, wherein the connector is placed between the inlet and the outlet.

### CROSS-REFERENCE TO RELATED APPLICATIONS

The present application is a continuation-in-part of U.S. patent application Ser. No. 10/996,731 filed on Nov. 24, 2004, which in turn claims priority benefits under 35 U.S.C. §119(e) of U.S. Provisional Patent Application Ser. No. 60/583,103 filed Jun. 25, 2004.

### FIELD OF THE INVENTION

The invention relates to an improved adapter used for connecting pipes in the field of plumbing.

### BACKGROUND OF THE INVENTION

Plumbing products generally known in the trade as “stub-outs” or “stub ells” are usually shaped like the letter “L” and typically connect the plumbing system of the residence, most of which lies within the wall or runs along or through the floors joists, and the final control device. The final control device is normally the stop valve under the vanity, near the toilet, under the kitchen sink, or that which connects to the tub spout.

Stub-outs, or adapters, are normally made of copper tube, usually ½″ nominal in size, but are sometimes made out of ¾″ nominal copper tube. Their function is typically the same, except that the ¾″ stub-out has greater capacity, in terms of flow rate, owing to its larger diameter. But, for the most part, they are made of ½″ nominal copper tubing.

The stub-out typically incorporates a brass fitting at one end, which is usually attached to the copper tubing by means of solder. Soldering the fitting to the end of the stub-out normally entails time and effort in addition to posing a safety hazard due to the heat and open flame. At the other end, the copper tubing is formed into a bullet shape and sealed, typically by using flame, flux and solder. FIG. 1 depicts a stub-out known in the prior art.

In practice, the plumbing system, commonly known as the “rough” plumbing, is run through the walls or through and along the floors joists before the finished flooring has been installed and before the wallboard has been applied. Therefore, all the wall studs are normally visible and the floor joists are usually accessible. The rough plumbing is usually run to each point of use, such as a sink, a vanity, a toilet, a washing machine, a bathtub, and/or a shower. A stub-out, or adapter, is often attached to each termination point of the rough plumbing, and the “stub-out” will make a transition from the rough plumbing to some point beyond where the finished surface will be.

Once the rough plumbing is completed, it may be checked for leaks prior to attaching final control devices. Checking for leaks usually entails pressurizing the entire plumbing system with air. If the system passes, and there are no leaks, the system may be depressurized and the task of putting up wallboard and closing up all the walls may begin. The rough plumbing will then normally be concealed behind the walls or floors except for the bullet-nosed ends of the stub-outs.

The “finished” plumbing may be installed and attached to the exposed parts of the stub-outs. Normally, prior to attaching finished plumbing, the bullet-nosed end of the stub-out may be cut off and de-burred to clean off any metal shavings or other debris. This usually takes some time and effort to properly clean and de-burr the cut. Moreover, plumbers may cut themselves in the process.

Additionally, input tube 12 of stub-out typically involves bending a copper tube to provide a 90° bend or bend that has input tube 12 generally perpendicular to output leg 16. The act of bending copper tube 18 may constitute a significant part of the total cost of stub-out since it involves a typically powerful machine to make the bend and several steps in the manufacturing process, where additional steps in manufacturing normally inflates costs. In some cases, the act of bending copper tube 18 to provide input tube 12 may constitute approximately 25%-45% of the total cost of stub-out 10.

The costs and efforts associated with bending copper tube 18 may be exacerbated in the event the bending is not properly performed, which results in input tube 12 being at an undesirable angle relative to output leg 16.

What is desired, therefore, is a stub-out that reduces time and effort to install. Another desire is to provide a stub-out that reduces safety hazards normally encountered while soldering or de-burring a stub-out. A further desire is a stub-out that is easy to install to rough and/or finished plumbing. Yet another desire is a stub-out that without the associated costs and efforts due to bending. Still another desire is a stub-out that may provide an input tube at a select angle relative to an output tube without the associated costs and efforts due to bending.

### SUMMARY OF THE INVENTION

It is, therefore, an object of the invention to provide a stub-out that is easy to install and use with rough or finished plumbing.

Another object is to provide a stub-out that eliminates the steps of soldering, cutting, and/or de-burring so that safety hazards are reduced.

A further object is a stub-out that reduces installation time or effort.

Yet another object is a stub-out that provides an inlet without the associated costs and efforts due to bending.

Still a further object is a stub-out that permits an inlet to be connected to an outlet in a select angular relation.

These and other objects of the invention are achieved by a plumbing adapter for connecting rough plumbing to finished plumbing, including an inlet adapted to be attached to the rough plumbing, an outlet having an outer diameter adapted to be attached to the finished plumbing, and a connector having a first end attached to the inlet and a second end with an inner diameter adapted to fit around the outer diameter, wherein the connector is placed between the inlet and the outlet.

In some embodiments, the inlet includes a fitting adapted to be attached to the rough plumbing. In other embodiments, the inner diameter is in contact with the outer diameter in at least one location. In some of these embodiments, the outer diameter includes a groove.

Optionally, the inner diameter includes a groove that mates with the groove of the outer diameter. Another option is an O-ring placed in the groove of the outer diameter.

The inner diameter has an axis extending in an axial direction that is at an angle relative to the inlet.

A manner for securing the outer diameter within the inner diameter may include a protrusion extending inwardly from a localized area or around the entire inner diameter.

In another manner, the inner diameter and the outer diameter have mating threads for securing the inner diameter to the outer diameter. In a further manner, the inner diameter is adhered to the outer diameter. In yet another manner, a spacer placed between the inner diameter and the outer diameter for securing the inlet to the connector. In some of these embodiments, the spacer is a compressible ring.

In another aspect of the invention, the plumbing adapter includes a connector placed between the inlet and the outlet for connecting the inlet at an angular relation to the outlet without bending the inlet relative to the outlet.

In some embodiments, the inlet is at an angle of between approximately 0° and 180° relative to the outlet. In other embodiments, the adapter includes a plurality of connectors, each having an inner diameter adapted to fit around the outer diameter. Optionally, each connector has an angle, defined by an axis passing through the inner diameter in an axial direction and the inlet, different than a next angle of a next connector.

### BRIEF DESCRIPTION OF THE DRAWINGS

FIG. 1 depicts the plumbing adapter in accordance with the prior art.

FIG. 2 depicts the stub-out in accordance with the invention.

FIG. 3 depicts the stub-out shown in FIG. 2 with a crimped attachment.

FIGS. 4a and 4b depict the stub-out shown in FIG. 2 with a push fit attachment.

FIG. 5 depicts the stub-out shown in FIG. 2 with an interference attachment.

FIG. 6 depicts the stub-out shown in FIG. 2 with an injection molded attachment.

FIG. 7 depicts the plumbing adapter in accordance with the invention.

FIG. 8 depicts another embodiment of the second end of the plumbing adapter shown in FIG. 2.

FIG. 9 depicts another view of the second end of the plumbing adapter shown in FIG. 8.

FIG. 10 depicts a valve attached to the second end of the plumbing adapter shown in FIG. 8.

FIG. 11 depicts an internal member to be inserted into the second end of the plumbing adapter shown in FIG. 8.

FIG. 12 depicts the internal member inserted into the second end of the plumbing adapter shown in FIG. 8.

FIG. 13 depicts a threaded second end of the plumbing adapter shown in FIG. 8.

FIG. 14 depicts a valve threaded onto the second end of the plumbing adapter shown in FIG. 8.

FIG. 15 depicts another valve threaded onto the second end of the plumbing adapter shown in FIG. 8.

FIGS. 16a and 16b depict a valve crimped onto the second end of the plumbing adapter shown in FIG. 8.

### DETAILED DESCRIPTION OF THE INVENTION

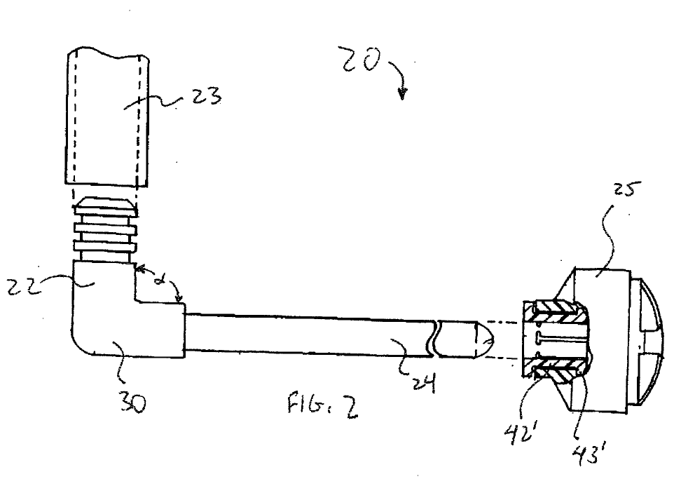

As shown in FIG. 2, stub-out 20 includes inlet 22 adapted to be attached to rough plumbing 23, outlet 24 adapted to be attached to finished plumbing, and connector 30 for connecting inlet 22 with outlet 24. More specifically shown in FIGS. 2-6, connector 30 includes inner diameter 36 adapted to fit around outer diameter 26 of outlet 22. Also shown in FIG. 2 is push on removable cap 25, which will be described in more detail below.

As shown, inner diameter 36 is large enough such than outer diameter 26 may be placed inside. However, in other embodiments, outer diameter 26 is similar or larger in size than inner diameter 36 so that an interference fit is achieved between inner diameter 36 and outer diameter 26. FIG. 5 depicts such an interference fit.

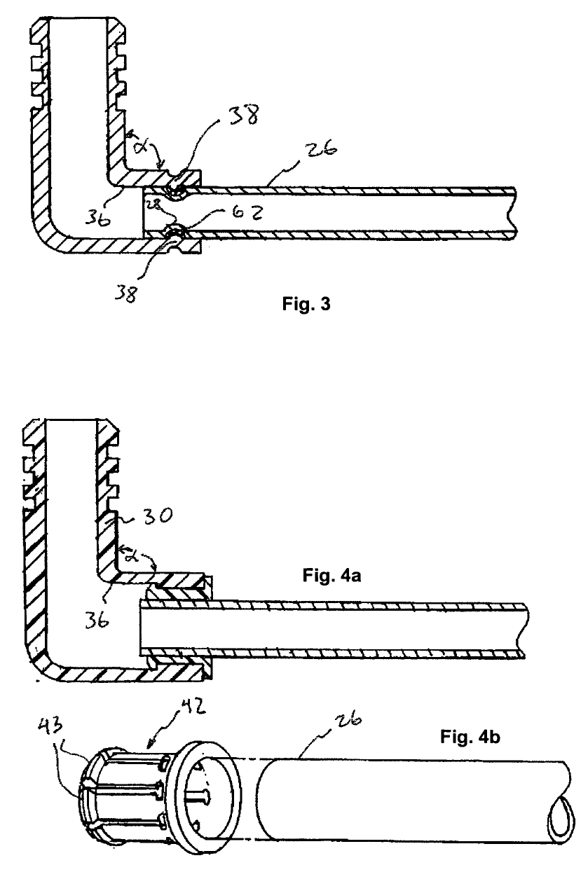

As shown in FIG. 3, inner diameter 36 is in contact with outer diameter 26 in at least one location, such as groove 38 of inner diameter 36 mating with groove 28 of outer diameter 26. As shown, groove 38 fits in or mates with groove 28 of outer diameter 26, wherein the mating or fit of groove 38 within groove 28 enhances friction and a secure attachment between outer diameter 26 and inner diameter 36. O-ring 62 is placed between the grooves to inhibit fluid from leaking. In further embodiments, such as the interference fit of FIG. 5 or where inlet 22 is soldered to connector 30, inner diameter 36 has multiple contact points with outer diameter 26.

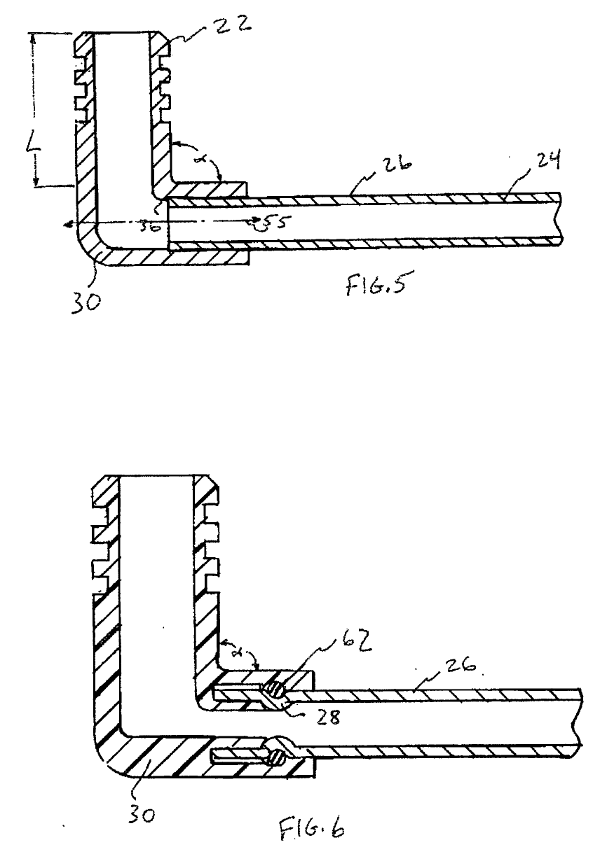

As shown in FIG. 6, outer diameter 26 includes groove 28, where groove 28 enhances friction and a secure attachment between outer diameter 26 and inner diameter 36. O-ring 62 is placed in groove 28 to enhance sealing between outer diameter 26 and inner diameter 36 and inhibit fluid from leaking out between the connection of connector 30 and outlet 24.

FIG. 6 depicts connector 30 being injected molded onto outlet 24, where outlet 24 is placed within a mold prior to injecting plastic into the mold where the plastic hardens and secures connector 30 around outlet 24.

As shown in FIGS. 4a and 4b, connector 30 includes spacer 42 placed between inner diameter 36 and outer diameter 26 for securing connector 30 to outlet 24. In some embodiments, spacer 42 is a compressible ring. Spacer 42 or compressible ring acts as a gasket to seal the connection between connector 30 and outlet 24.

In further embodiments, a plurality of teeth 43 is utilized in addition to or instead of spacer 42, where each tooth extends from inner diameter 36 radially inward toward outer diameter 26 for securing connector 30 to outlet 24. In yet other embodiments, outer diameter 26 is threaded into inner diameter 36 where the threads of inner diameter 36 mate with the threads of outer diameter 26. In still other embodiments, inner diameter 36 is adhered to outer diameter 26 with glue, cement, and the like. In addition, other securing mechanisms may be used, such as fasteners, rivets, nails, screws, and the like.

As shown in FIG. 2, cap 25 is a combination of spacer 42′ and plurality of teeth 43′ shown in FIGS. 4a-4b and where cap 25 is used to removably seal outlet 24 (the benefits of removably sealing outlet 24 is explained in greater detail below). Although outlet 24 is shown to be closed with a bullet shaped end, such end would be removed when removably sealed with cap 25.

In all embodiments shown in FIGS. 2-6, the angle α determines the angular relation between inlet 22 and outlet 24. Generally, angle α is typically approximately 90 degrees. However, connector 30 may be mass produced to come in varying combinations of inner diameters 36 and angle α. For example, angle α may be 45 degrees while inner diameter 36 may be 1 cm or 2 cm in diameter. On the other hand, angle α may be 60 degrees while inner diameter 36 may be 1 cm or 2 cm. In other words, numerous combinations of inner diameter 36 size and angle α may be used and the above examples are not a limitation of the invention.

In this manner, a user need only select connector 30 with a desired inner diameter 36 size and a desired angle a for use in connecting inlet 22 and outlet 24 and the desired angular relation with one another. Typical angles for angle α vary between approximately 0 degrees and 180 degrees. Typical sizes for inner diameter 36 vary between approximately ⅜ inch and approximately ¾ inch.

By providing a plurality of connectors 30 with a plurality of inner diameter sizes and angles α, and combinations thereof, bending inlet 22 relative to outlet 24 is obviated, including the associated costs and time. In addition, the length of inlet 22 may also be provided in a plurality of lengths (shown as L) and in various combinations with the inner diameter size and angle α.

Although inner diameter 36 of connector 30 is shown to have longitudinal axis 55 as in FIG. 5, or axis that extends in an axial direction, that is generally perpendicular to said inlet 22, axis 55 may be placed at any angle relative to inlet 22, where this angle has a direct relation to angle α.

Since the act of bending inlet 22 relative to outlet 24 is obviated, the equipment and time to perform the bending is not needed, thereby making the manufacturing process for providing stub-out 20 more efficient.

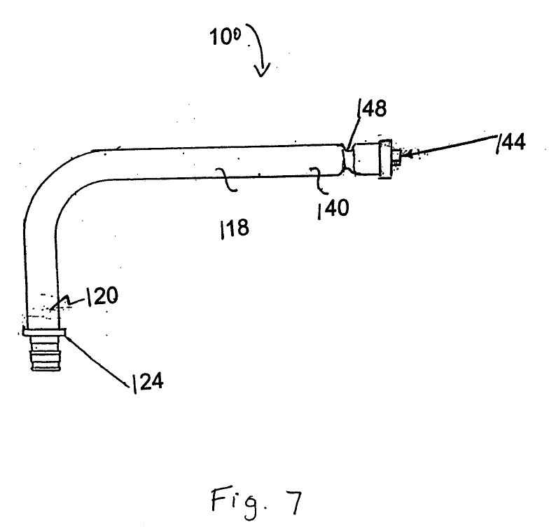

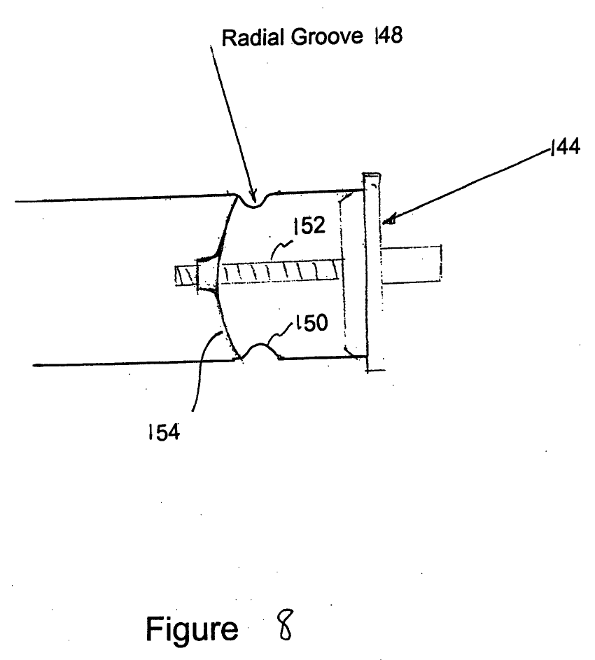

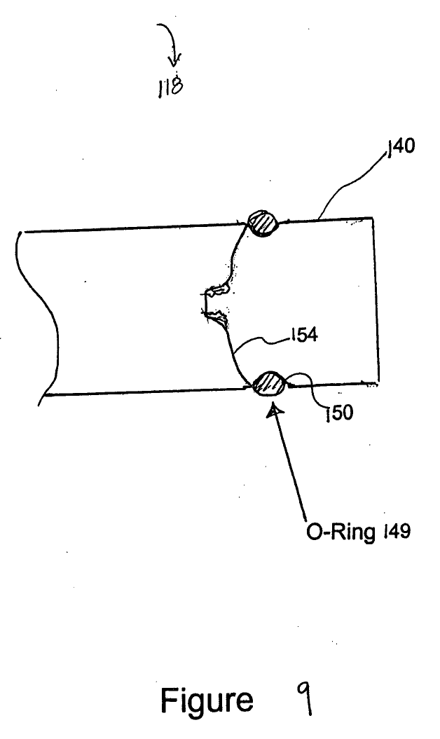

FIG. 7 depicts adapter 100 in accordance with the invention. Adapter 100 includes elongated tube 118 having first end 120 and second end 140 where fitting 124 is attached to first end 120 and sealer 144 is attached to second end 140.

In FIG. 7, fitting 124 is shown to be a connection between first end 120 and the rough plumbing. Fitting 124 may be threaded so that it may be screwed to the rough plumbing. In other embodiments, fitting 124 may be sweated or welded to the rough plumbing. As shown, fitting 124 is crimped or soldered (sweated) to first end 120 but, in further embodiments, may be adhered or screwed to first end 120 by mating threads on both first end 120 and fitting 124 or by crimping. In a further embodiment, first end 120 and fitting 124 are integrally connected or formed, perhaps by high speed spinning during tube forming. Integrally connecting first end 120 to fitting 124 may yield the following advantages: First, one hundred per cent automated fabrication of the stub-out, with the virtual elimination of labor content. Second, total elimination (where a removable plug is used) or a partial elimination of heat, flame, acid flux, solder in the manufacturing processes used in manufacture of these stub-out items. Third, due to automation, much improved quality and uniformity of the fabricated items. Fourth, the elimination of a potential leak point where the brass fitting is joined to the copper tube.

By crimping fitting 124 to first end 120, the entire process of fabricating a stub-out can be easily automated. Moreover, there will no longer be any requirement for heat, flame, acid flux, or solder, thus eliminating flame, fire danger, fuel expense, and workplace health and safety hazards. And tube 118 will not have to be sanded and/or wire brushed to expose bare copper, prior to soldering, because the entire soldering process will disappear, and the need to prepare the end to be soldered by disclosing bare copper.

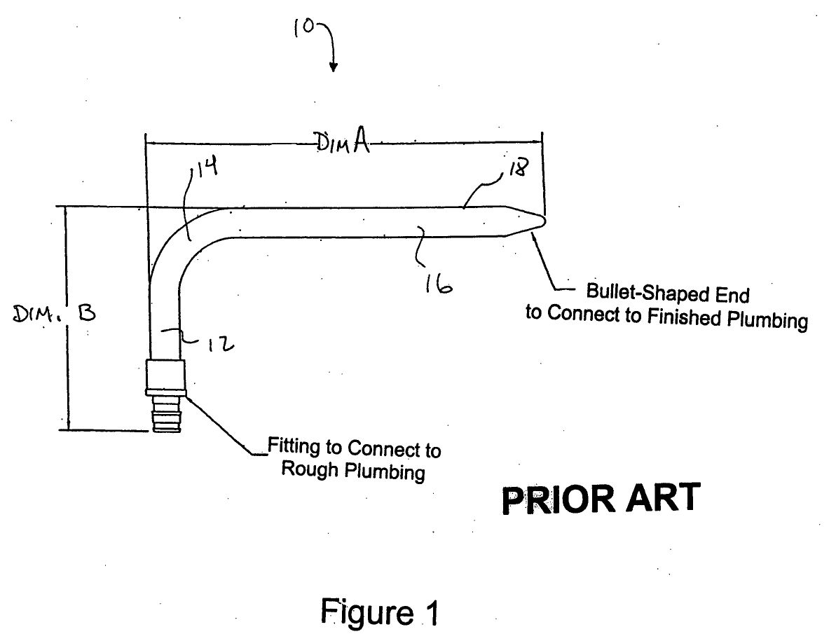

Sealer 144 does away with the traditional bullet shaped end shown in the prior art of FIG. 1 and described above. This is because, in most applications, the bullet shaped end was used until pressure testing was completed, whereupon the bullet shaped end was then cut off and discarded.

As shown, sealer 144 is threaded onto second end 140, where second end 140 is also threaded to mate with sealer 144. In other embodiments, sealer 144 is merely pushed into second end 140, or vice versa, whereby sealer 144 and second end 140 are connected to one another by interference fit. In a further embodiment, the temporary seal or plug can be applied in the factory automatically. In a further embodiment, sealer 144 may be similar to item 25 of FIG. 2.

After the system is pressure tested, sealer 144 will be unthreaded and removed. The time and expense of cutting off the bullet shaped end, deburring the cut, removing any remaining metal slivers, and cleaning out the cut end are eliminated. Also, there will be material savings since there will no longer be any discarded second ends 140 from stub-outs.

Additional savings may be realized in the cases where the plumber does not properly clean out metal filings, or slivers of metal, after cutting the bullet shaped end prior to installation of the finished plumbing. In those cases, they end up fouling the faucets, increasing repairs to the plumbing system, and/or the filings end up in somebody's intestinal tract.

Further savings may be realized when purchasing later stub-outs. It is envisioned that stub-outs may be sold with and without sealer 144, where the latter would be cheaper. The plumber will re-use sealer 144 from a previous installation with the stub-outs purchased without sealer 144.

Optionally, second end 140 includes groove 148 for placement of o-ring 149 for enhancing a fluid tight seal when connected with finished plumbing. It is best if the radially-inward groove 148 is formed into the tube at the factory, but such radially-inward groove could likewise be imparted at the worksite with a special grooving tool.

In addition, groove 148 may provide ridge 150, or a protrusion, inside the tube (see FIG. 8) so that it may be possible to design a sealer that can snap in place behind ridge 150 to provide positive anchoring and sealing of second end 140. Ridge 150, or protrusion, may extend radially inward in a localized area of the inner diameter of second end 190. In other embodiments, protrusion 150 extends around the entire inner diameter.

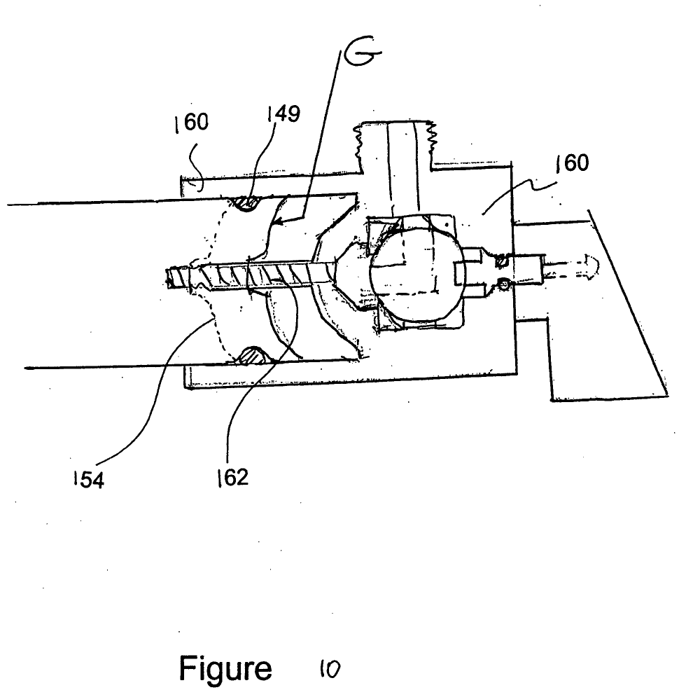

FIG. 8 shows a variation of sealer 144 where sealer 144 also includes closer 152 threaded into anchoring mechanism 154. After sealer 144 is removed by unthreading closer 152 from anchoring mechanism 154, the result would be adapter 100 as shown in FIG. 9.

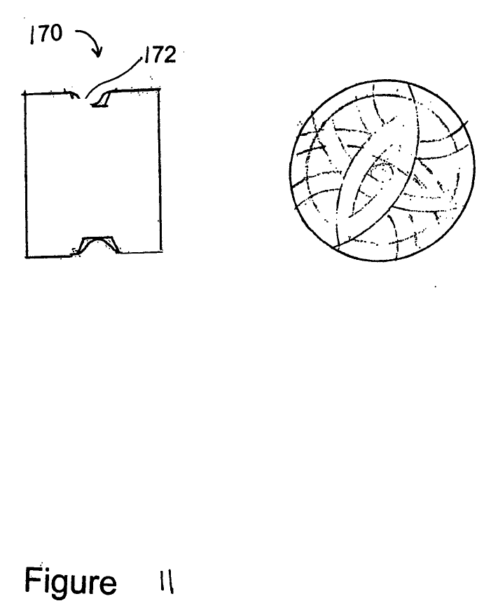

As shown in FIG. 9, tube 118 is open and anchoring mechanism 154 is lodged behind protrusion 150. Anchoring mechanism 154 snaps into position behind protrusion 150. Valve 160 of special design may be installed by attachment device 162 that screws, or threads, into the threads of anchoring mechanism 154. Anchoring mechanism 154 provides a secure anchor for valve 160 to prevent accidental removal of valve 160. See FIG. 10. Attachment device 162 is interchangeable with closer 152 because both have the same threads to mattingly engage with anchoring mechanism 154. Attachment device 162 may vary from closer 152 in any other physical characteristic and/or shape and need not be the same as closer 152. O-ring 149 provides a fluid tight seal with valve 160.

The process of installation is more specifically described as follows: a) Sealer 144 is removed leaving anchoring mechanism 154 secured to protrusion 150. b) Next, O-ring 149 is installed onto the radially oriented groove 148. c) Next, valve 160 of special design, having a central, threaded attachment device 162 is installed. Valve 160 is threaded until the valve inlet cavity bottoms against the end of the tube. The diameter of the valve inlet portion is made to specification provided by the standards, and the O-ring is sized in such a manner as to provide a liquid seal. The advantage of this type of valve is obvious in that no tools are required. No heat, no flame, no solder, and no wrenches are required, as with traditional types of valves available on the market.

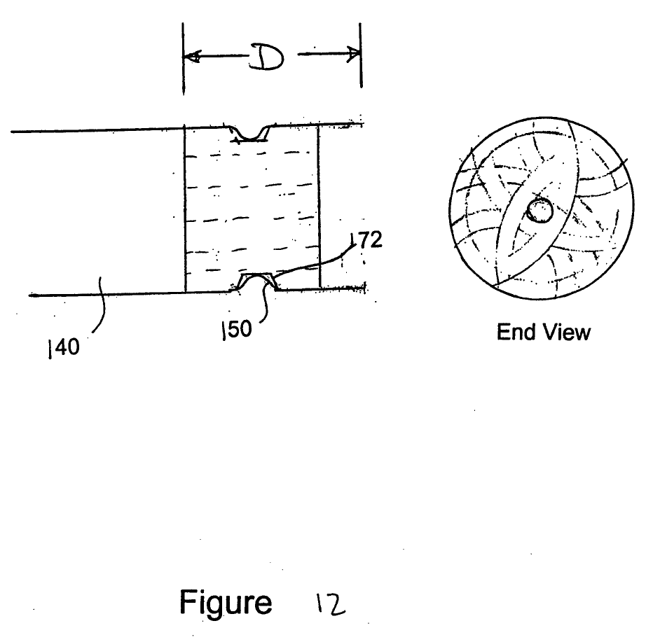

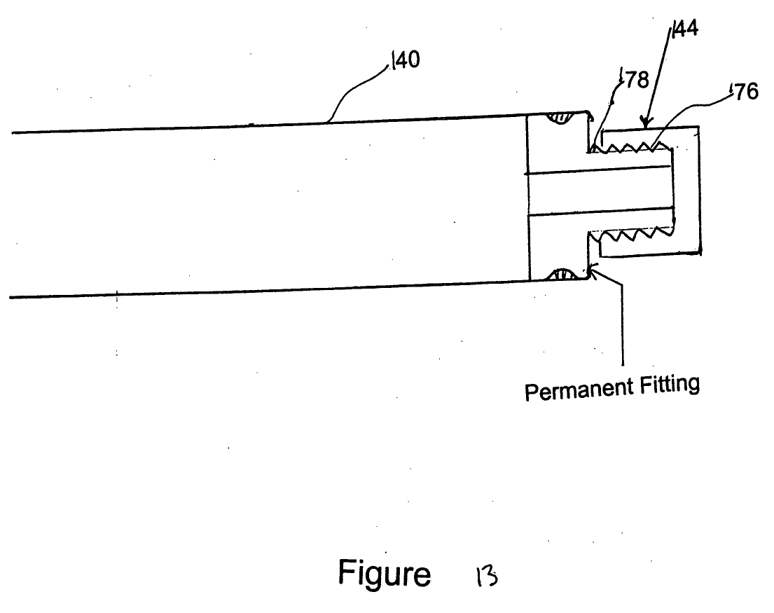

In a further, alternate improvement to adapter 100, shown in FIG. 11, internal member 170 with external groove 172 in an outer diameter of internal member 172 is used instead of anchoring mechanism 154. Internal member 170 with radially oriented groove 172, either cut or molded into it, is inserted into second end 140 to a desired depth “D” as shown in FIG. 12. Groove 172 mates with protrusion 150, thereby locking internal member 170 in place in an axial position. Being anchored axially in tube 118, internal member 170 will be properly positioned to accept valve 160, which by means of a threaded or bayonet-type connecting device, will connect to internal member 170. Prior to final connection of valve 160, O-ring 149 would be installed into groove 148 of second end 140.

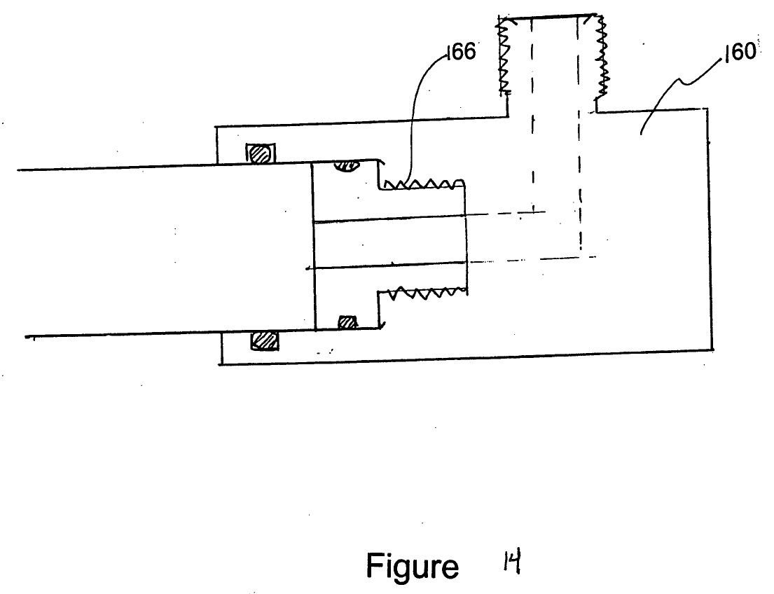

FIG. 13 depicts another embodiment of the invention where sealer 144 includes threads 176 for removably attaching to threads 178 of second end 140. After pressure testing, the threaded sealer 144 is removed and valve 160, also with threads 166 for matingly attaching to threads 176, is mounted. See FIG. 14. Valve 160 as pictured in FIG. 14 is equipped with O-ring 149, or other elastomeric seal member, in the bore of the tube 118 engaging end. The elastomeric seal provides the fluid seal, while the thread engagement between male and female ends, respectively, provide for mechanical holding of valve 160 to second end 140. In practice, the valve is very easy to install, since there is no requirement for torch, sweat, solder, heat, flame, tools, or even Teflon tape or pipe dope. No tools are required.

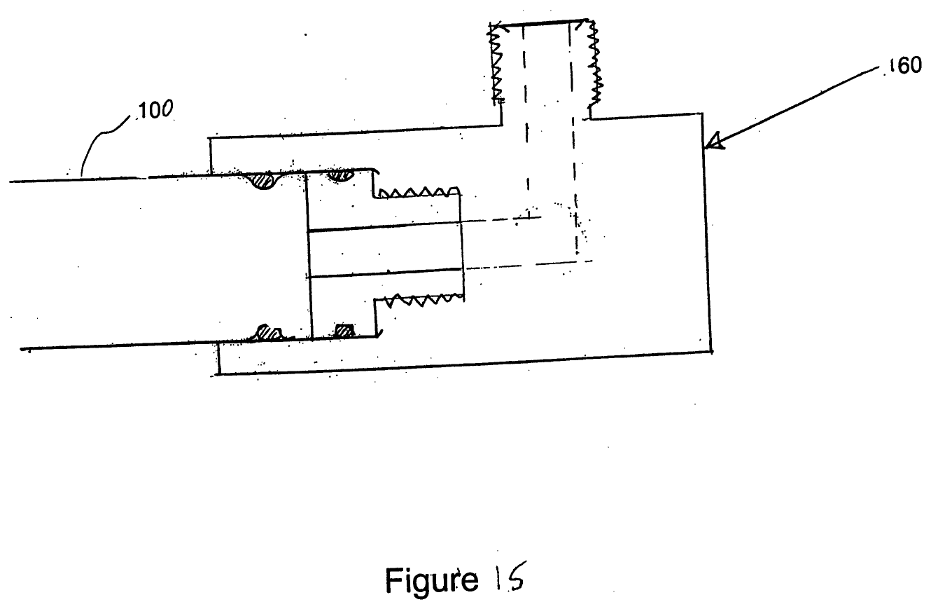

In yet another embodiment, FIG. 15 shows adapter 100 and valve 160 equipped with two o-ring grooves and two o-rings. After pressure testing, sealer 144 is removed and a first o-ring is mounted onto a first external, radially-oriented sealing groove. Next, valve 160 is mounted onto the end of the stub-out. Note that the specially designed valve, in this instance, has no internally-mounted o-ring, or other elastomeric seal, since there is one now mounted (or mountable) on the o-ring groove of the tube. Although pictured with female engaging threads, to engage a permanent sealing plug element with matching male threads, it is understood that the valve could as easily be provided with male threads, to engage female threads of a permanent sealing member at the end of the stub-out.

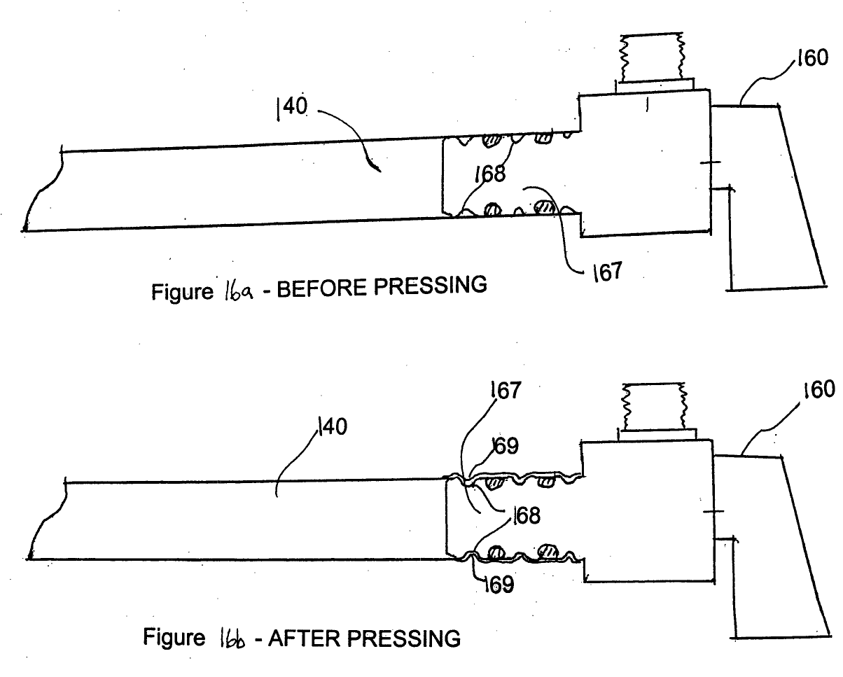

FIGS. 16a and 16b depict another embodiment of connecting second end 140 and valve 160. As shown in FIG. 11a, valve 160 includes insert 167 for insertion into second end 140. Insert 167 further includes notch 168. Second end 140 is made of a deformable material so that it may be crimped, or deformed. As shown in FIG. 11b, second end 140 is crimped so that bend 169 forms in second end 140 as a result of an external force placed on second end 140. When bend 169 is formed in notch 168, second end 140 and insert 167 are locked together, thereby securing valve 160 to second end 140. The final result is that it will then be much more difficult (practically impossible) to separate valve 160 from tube 118, thereby effecting a permanent seal, and also providing visual confirmation that the two members, tube 118 and valve 160, have been irreversibly combined. A further means of verification, should one be deemed necessary, is to provide the plumber with a fixed caliper (a “go, no-go gauge”) that will tell him that sufficient compression has occurred, and that the installation is complete and to specification.

It is understood that all limitations for sealing first end 120 of stub-out 100 of FIGS. 7-17b are applicable for sealing second end 140 of stub-out 100, and vice versa. Also, all limitations for connecting connector 30 to inlet 22 of FIGS. 2-6 are applicable for sealing second end 140, and vice versa.

What is claimed is:

1. A plumbing adapter for connecting rough plumbing to finished plumbing, comprising:
an inlet adapted to be attached to the rough plumbing;
an outlet having an outer diameter adapted to be attached to the finished plumbing; and
a connector having a first end attached to said inlet and a second end with an inner diameter adapted to fit around said outer diameter;
wherein said connector is placed between said inlet and said outlet.

2. The adapter according to claim 1, wherein said inlet includes a fitting adapted to be attached to the rough plumbing.

3. The adapter according to claim 1, wherein said inner diameter is in contact with said outer diameter in at least one location.

4. The adapter according to claim 1, wherein said outer diameter includes a groove.

5. The adapter according to claim 4, wherein said inner diameter includes a groove that mates with said groove of said outer diameter.

6. The adapter according to claim 4, further comprising an O-ring placed in said groove of said outer diameter.

7. The adapter according to claim 1, wherein said inner diameter has an axis extending in an axial direction that is at an angle relative to said inlet.

8. The adapter according to claim 1, wherein said inner diameter further comprises a protrusion extending inwardly from a localized area.

9. The adapter according to claim 8, wherein said localized area extends around an entire said inner diameter.

10. The adapter according to claim 8, wherein said localized area extends around a part of said inner diameter.

11. The adapter according to claim 1, wherein said inner diameter and said outer diameter have mating threads for securing said inner diameter to said outer diameter.

12. The adapter according to claim 1, wherein said inner diameter is adhered to said outer diameter.

13. The plumbing adapter according to claim 1, further comprising a spacer placed between said inner diameter and said outer diameter for securing said inlet to said connector.

14. The plumbing adapter according to claim 13, wherein said spacer is a compressible ring.

15. A plumbing adapter for connecting rough plumbing to finished plumbing, comprising:
an inlet adapted to be attached to the rough plumbing;
an outlet adapted to be attached to the finished plumbing; and
a connector placed between said inlet and said for connecting said inlet at an angular relation to said outlet without bending said inlet relative to said outlet.

16. The plumbing adapter according to claim 15, wherein said connector includes a first end attached to said inlet and a second end with an inner diameter adapted to fit around said outer diameter.

17. The plumbing adapter according to claim 15, wherein said inlet is at an angle of between approximately 0° and 180° relative to said outlet.

18. The plumbing adapter according to claim 15, further comprising a plurality of connectors, each having an inner diameter adapted to fit around said outer diameter.

19. The plumbing adapter according to claim 18, wherein each connector has an angle, defined by an axis passing through said inner diameter in an axial direction and said inlet, different than a next angle of a next connector.

20. A plumbing adapter for connecting rough plumbing to finished plumbing, comprising:
an inlet adapted to be attached to the rough plumbing;
an outlet having an outer diameter adapted to be attached to the finished plumbing; and
a connector placed between said inlet and said outlet for connecting said inlet at an angular relation to said outlet without bending said inlet relative to said outlet;
said connector includes a first end attached to said inlet and a second end with an inner diameter adapted to fit around said outer diameter;
wherein said outer diameter is placed within and secured to said inner diameter.
